(19) United States
(12) Patent Application Publication
(10) Pub. No.: US 2004/0143479 A1
(43) Pub. Date: Jul. 22, 2004

(54) Measuring economic cost/benefit of human/machine interfaces

(75) Inventors: Gregory A. Jamieson, Toronto (CA); Dal Vernon C. Reising, Woodbury, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/347,719

(22) Filed: Jan. 21, 2003

(51) Int. Cl. G06F 17/60

(52) U.S. Cl. 705/10

(57) ABSTRACT

An apparatus, method, system, and signal-bearing medium are provided to quantitatively justify to the economic payoff of designing and implementing advanced human interface technology. Metrics of operator and system performance are defined in a weighted function that indicates the economic cost/benefit of new HITs (Human Interface Technologies), data is collected from the metrics, a cost function is computed, and a cost comparison for alternative human interface design approaches is performed. In this way, a quantitative justification for designing and implementing advanced HITs is established and predictions for returns on investments in HITs are provided.

### FIELD

An embodiment of the invention relates generally to process industries and more particularly to a computer model for measuring the economic cost/benefit of human-machine interfaces in the process industries.

### BACKGROUND

Many industries (e.g. process industries such as electricity generation) use complex machines that require a sophisticated operator or operators. Using an advanced human-machine interface (often called Human Interface Technology or HIT) can increase productivity for a human operator and can thus lead to cost savings, but these cost savings can be difficult to quantify. Further, designing and implementing these advanced human-machine interfaces can be very expensive. Thus, before expending the time and money to design, develop, or purchase advanced human-machine interfaces, the purchaser would like to know that the price to obtain the advanced human-machine interface will be justified by the cost savings that such an interface will bring.

The computer software industry has conducted studies to measure the cost/benefit of its user interfaces. These software studies have demonstrated that human factors input in the development of computer tools can lead to substantial cost benefits. But, these software studies focused on user tasks that are discrete and repetitive using simple measures of task completion time and accuracy, which do not accurately characterize the complex machines of the process industries. Thus, the studies performed by the software industry are of little use when attempting to conduct a cost/benefit analysis of the process industry.

Other studies have been performed in the process control field, which is an area of research that focuses on measurement techniques in human factors. These studies have struggled to identify meaningful measures of human performance. Also, they are hindered by using metrics such as the frequency of control actions and the accuracy of fault diagnoses, which are not easily translated into real dollar amounts and are thus not helpful in doing an economic cost/benefit analysis.

Thus, there is a need for a solution that can perform a cost/benefit analysis of a human-machine interface.

### SUMMARY

An apparatus, method, system, and signal-bearing medium are provided to quantitatively justify the economic payoff of designing and implementing advanced human interface technology. Metrics of operator and system performance are defined in a weighted function that indicates the economic cost/benefit of new HITs (Human Interface Technologies), data is collected from the metrics, a cost function is computed, and a cost comparison for alternative human interface design approaches is performed.

In this way, a quantitative justification for designing and implementing advanced HITs is established and predictions for returns on investments in HIT are provided.

### BRIEF DESCRIPTION OF THE DRAWINGS

FIG. 1A depicts a flowchart of example processing, according to an embodiment of the invention.

FIG. 1B depicts a flowchart of example processing for calculating a cost benefit index, according to an embodiment of the invention.

FIG. 2 depicts a block diagram of an example computer for implementing an embodiment of the invention.

### DETAILED DESCRIPTION

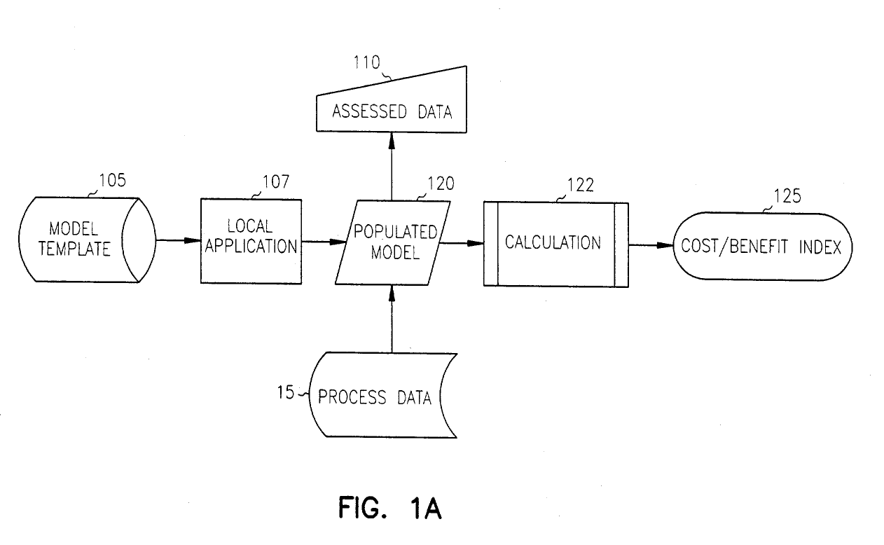

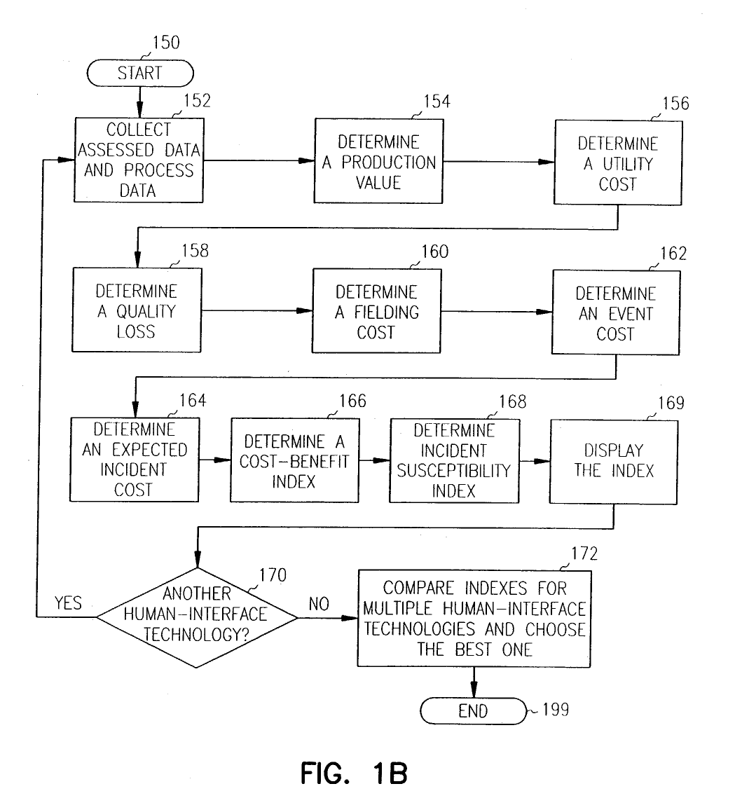

FIG. 1A depicts a flowchart of example processing, according to an embodiment of the invention.

The model template 105 is filled in with specific variables, constants, and weights to cater the model template 105 to the local application 107.

The process data 115 is used to assess control performance in the model. In an embodiment, the process data 115 may be collected from either a real or simulated process by way of a data historian, but in another embodiment any appropriate collection mechanism may be used.

The assessed data 110 may include assessments of operator performance that are performed manually or through the use of methods not directly related to the process data 115.

The populated model 120 may include the model template 105 tailored to the local application as modified by the assessed data 110 and the process data 115.

The calculation 122 computes the cost/benefit index using the populated model 120 as further described below and in FIG. 1B. The calculation 122 uses a Generic Cost Model, which is a comprehensive model based on assumptions about data available for a particular process. For example, assessing the impact of an interface on production values necessitates having established targets and monetary values for each of the process streams. Without these values, only performance-oriented metrics could be brought to bear. To provide depth in a general model, two versions are described below. One version, the Omniscient Generic Model, uses background data to perform the cost/benefit calculation. The other version, the Humanist Generic Model, is derived from the Omniscient Model, but is less demanding in terms of the required inputs.

Omniscient Generic Model

The Omniscient Generic Model may be used when rich data is available to support the application of the model. The main equation expresses the overall cost or benefit of the HIT as a function of the production value, utility costs, quality losses, event costs, expected incident costs, and the fielding cost:

Cost/benefit=Prod Val−UtilityCost−QualityLoss−FieldingCost−EventCost−ExpectedIncidentCost

The production value (ProdVal) term is expressed as the sum of the accumulated values of process flows. An integral over the observation time of the difference between the targeted flow rate and the flow deviation is multiplied by the value of each flow. The set of product flows is defined to be the set of process flows minus the utility flows. A target rate and production value are defined for each product flow.

$$ProdVal = {\sum }_{i = 1}^{n} [ {\int }_{0}^{T} ( {TargetFlow}_{i} - {FlowDev}_{i} ⅆ t ] \times {FlowValue}_{i}$$

for n process (i.e., non-utility) flows (i); T=observation time.

The Flow Deviation factor is composed of three different characterizations of flow deviation expressed in four elements. The first element refers to a target deviation. The second and third elements refer to a range excursion. The final element refers to a deviation in a trajectory deviation. The binary lambda coefficients indicate which of the four (if any) deviations are taking place at any given time.

$${FlowDev}_{i} = [ \begin{matrix}{λ}_{1} \vert {Flow}_{i} - {TargetFlow}_{i} \vert - \\ {λ}_{2} ( {Flow}_{i} - {RangeFlow}_{UL} ) - \\ {λ}_{3} ( {RangeFlow}_{LL} - {Flow}_{i} ) - \\ [ {λ}_{4} ( \vert {TrajFlow}_{i} - {Flow}_{i} \vert - \\ {TrajDeadBand}_{i} ) ]\end{matrix} ] ,$$

where:

λ₁, λ₂, λ₃, λ₄ε[0,1], (i.e., the conditions are binary).

λ₁+λ₂+λ₃+& λ₄≦1, (i.e., zero or one condition can be active at any time).

The utility cost is expressed as the sum of the product of the flow rate of utility variables and their associated costs.

$$UtilityCost = {\sum }_{u = 1}^{k} {\int }_{0}^{T} ( {UtilityRate}_{u} \times {UtilityCost}_{u} ) ⅆ t$$

for k utilities (u) such as electricity, steam, furnace fuel, cooling water, etc.

Quality losses are expressed as the product of the flow rate of process variables and a quality penalty for each.

$$\begin{matrix}QualityLoss = {\sum }_{i = 1}^{n} {\int }_{0}^{T} ( {Flow}_{i} \times {QualityPenalty}_{i} ) ⅆ t \\ for n process variables .\end{matrix}$$

Fielding costs are factored into the model as fixed costs for operator training, display development, and implementation. These factors are scaled according to the display lifecycle relative to the observation time.

$$FieldingCost = \frac{\begin{matrix}( TrainingCost + DisplayDevelopmentCost + \\ ImplementationCost )\end{matrix}}{( DisplayLifeCycle / T )}$$

The event cost term accounts for the costs associated with abnormal events that take place over the observation period. The first seven factors in this term are fixed costs that must be determined for each event. The last factor, a product of the available flare flows and the value of the flared stream, accounts for flare losses.

$$\begin{matrix}EventCost = EquipmentRepair / Replacement + SpillCleanUp + \\ WasteDisposal + InvestigationLabor + RepairLabor + \\ OffSpecBlending + LegalCosts / Fine + \\ {\sum }_{a = 1}^{m} ( {FlareFlow}_{a} \times {StreamValue}_{a} ) \\ for m flare flows ( a ) .\end{matrix}$$

The expected incident cost combines a series of operator performance and subjective rating factors to anticipate likely future incident costs. The term assumes the availability of an event frequency projection, an anticipated average cost of those events, and the lifecycle of the display.

$$ExpectedIncidentCost = \frac{\begin{matrix}( 1 - RiskMitigationFactor ) \\ ( EventFreq \times AvgEventCost )\end{matrix}}{( DisplayLifeCycle / T )}$$

The risk mitigation factor accumulates the weighted sum of four components associated with risk-averse behaviors and qualities. The coefficients here, and elsewhere in all three models, allow for flexibility in establishing the relative importance of each component and term in the model for a given company.

RiskMitigationFactor=[φ₁)FaultMgmtPerf+φ₂SitAwareness+φ₃SkillUtil+φ₄Assuredness]/4,

where: φ₁+φ₂+φ₃+φ₄=4, and 0<φ₁φ₂, φ₃, φ₄≧4.

Fault management performance is defined as a weighted sum of the ratios of detection time, correction time and recovery time over the off target time.

$$FaultMgmtPerf = [ \begin{matrix}{γ}_{1} ( \frac{DetectionTime}{OffTargetTime} ) + \\ {γ}_{2} ( \frac{CorrectionTime}{OffTargetTime} ) + \\ {γ}_{3} ( \frac{RecoveryTime}{OffTargetTime} )\end{matrix} ] / 3$$

where: γy₁+γ₂+γ₃=3, and 0≦γ₁, γ₂, γ₃≦3.

The off target time is defined as the sum of the anomaly detection time (not included if the anomaly is an anticipated unusual condition), the time for the operator to take a corrective action, and the time to recover the process. This last component introduces some variation in the model because recovery time will depend on time constants of the process. It may be modified in two ways: first, it may be adjusted by an expression of the system time constant. Second, it may be adjusted by a nominal recovery time that assumes perfect knowledge and perfect response on behalf of the operator.

OffTargetTime(i)=(αᵢ×AnomalyDetTime(i)+FirstContrCorrTime(i)+RecoveryTime(i)),

where: αᵢε[0,1] is the anomaly/anticipated unusual distinction.

The situation awareness component consists of weighted scores of state description, event awareness, and diagnosis accuracy assessments.

$$SitAwareness = [ \begin{matrix}{σ}_{1} ( \frac{StateDescScore}{100} ) + \\ {σ}_{2} ( \frac{EventAwarenessScore}{100} ) + \\ {σ}_{3} ( \frac{DiagnosisAcc}{3} )\end{matrix} ] / 3 ,$$

where: σ₁+σ₂+₃=3, and 0≦σ₁1, σ₂, σ₃≦3.

and: StateDescScore (0-100), EventAwarenessScore (0-100), and DiagnosisAccuracyε[0,1,2,3].

Skill utilization attempts to capture the combined proportions of operator skill that are exercised by the interface. These include the existing skill set, a new skill set (e.g., new training), judgment utilization, and education utilization.

$$SkillUtil = [ \begin{matrix}{α}_{1} ( \frac{ExistingSkillUtil}{100} ) + {α}_{2} ( \frac{NewSkillUtil}{100} ) + \\ {α}_{3} ( \frac{JudgementUtil}{100} ) + {α}_{4} ( \frac{EducationUtil}{100} )\end{matrix} ] / 4 ,$$

where: α₁+α₂+α₃+α₄=4, and 0≦α₁, α₂, α₃, α₄≦4

and: *Util=(0-100).

The assuredness component combines the weighted operator self-ratings of stress and self-confidence.

$$Assuredness = [ {β}_{1} ( \frac{SelfConfidence}{100} ) + {β}_{2} ( \frac{100 - StressScore}{100} ) ] / 2$$

where β₁+β₂=2, and 0≦β₁, β₂≦2,

and: SelfConfidence=(0-100) and StressScore=(100-0).

Humanist Generic Model

The Humanist Generic Model is derived from the Omniscient Model. The main difference is that the Humanist Generic Model accommodates limitations in the available economic data.

Similar to the Omniscient Model, the production value is still expressed as the sum of the accumulated values of flows. But, in the Humanist model, only product flows are considered (as opposed to all process flows) in the Product Value term. In addition, targets are not required to be established for the process flows. A second difference between the model equations is the absence of an expected incident cost term in the Humanist Model.

$$\begin{matrix}Cost / benefit = ProdVal - UtilityCost - QualityLoss - \\ EventCost - FieldingCost\end{matrix}$$

$$ProdVal = {\sum }_{p = 1}^{q} {\int }_{0}^{T} ( {Value}_{p} \times {Flow}_{p} ) ⅆ t for all q products ( p ) ;$$

$$T = observation time$$

$$\begin{matrix}UtilityCost = {\sum }_{u = 1}^{k} {\int }_{0}^{T} ( {UtilityRate}_{u} \times {UtilityCost}_{u} ) ⅆ t \\ for k “ Utility ( u ) ” \\ = electricity , steam , furnace fuel , cooling water , etc .\end{matrix}$$

$$\begin{matrix}QualityLoss = {\sum }_{i = 1}^{n} {\int }_{0}^{T} ( {Flow}_{i} \times {QualityPenalty}_{i} ) ⅆ t \\ for n process variables\end{matrix}$$

$$FieldingCost = \frac{\begin{matrix}( TrainingTime + DisplayDevelopmentCost + \\ ImplementationCost )\end{matrix}}{( DisplayLifeCycle / T )}$$

$$\begin{matrix}EventCost = EquipmentRepair / Replacement + SpillCleanUp + \\ WasteDisposal + InvestigationLabor + RepairLabor + \\ OffSpecBlending + LegalCosts / Fine + \\ {\sum }_{a = 1}^{m} ( {FlareFlow}_{a} \times {StreamValue}_{a} )\end{matrix}$$

for m flows (a).

The expected incident cost term has been removed from the Humanist model. In its place, a second equation combines the risk mitigation term with process variable performance and variance terms. The new term is referred to as Incident Susceptibility:

IncidentSusceptibility=[φ₁ Process VarPerf+φ₂ Process Variance+RiskMitigationFactor]/3

wherein: φ₁+φ₂+φ₃=3, and 0≧φ₁, φ₂, φ₃≧3.

The Process Variable Performance term allows for the inclusion of variables for which targets are available but are not directly related to product flows. The factors in this term mirror those in the Omniscient model.

$${ProcessVarPerf}_{i} = [ \begin{matrix}{λ}_{i} \vert {Flow}_{i} - {TargetFlow}_{i} \vert - \\ {λ}_{2} ( {Flow}_{i} - {RangeFlow}_{UL} ) - \\ {λ}_{3} ( {RangeFlow}_{LL} - {Flow}_{i} ) - \\ [ {λ}_{4} ( \vert {TrajFlow}_{i} - {Flow}_{i} \vert - \\ {TrajDeadBand}_{i} ) ]\end{matrix} ] ,$$

where:

λ₁, λ₂, λ₃, λ₄[0,1], (i.e., the conditions are binary), and

λ₁+λ₂+λ₃+λ₄≦1, (i.e., zero or one condition can be active at any time).

The process variance term recovers some of the information regarding process variable performance for variables without defined targets. Since target values are not defined, instead the variability in the process variables is used. The multi-dimensional variance is defined as an integral over time of the sum of the individual variable variances. This term captures the degree of stability in the process.

$$ProcessVariance = {\int }_{0}^{T} [ \frac{{\sum }_{i = 1}^{n} \frac{{( {VarVal}_{i} ( t ) - {aveVarVal}_{i} )}^{2}}{{aveVarVal}_{i}}}{n - 1} ] ⅆ t$$

for n process variables

RiskMitigationfactor=[φ₁FaultMgmtPerf−φ₂SitAwareness−φ₃SkillUtil−φ₄Assuredness]/4,

where: φ₁+φ₂+φ₃+φ₄=4, and 0≦φ₁, φ₂, φ₃, φ₄≦4.

FaultMgmtPerf=

$$FaultMgmtPerf = [ \begin{matrix}{γ}_{1} ( \frac{DetectionTime}{OffTargetTime} ) + \\ {γ}_{2} ( \frac{CorrectionTime}{OffTargetTime} ) + \\ {γ}_{3} ( \frac{RecoveryTime}{OffTargetTime} )\end{matrix} ] / 3 ,$$

where: γ₁+γ₂+γ₃=3, and 0≦γ₁, γ₂, γ₃≦3.

$$SitAwareness = [ \begin{matrix}{σ}_{1} ( \frac{StateDescScore}{100} ) + \\ {σ}_{2} ( \frac{EventAwarenessScore}{100} ) + \\ {σ}_{3} ( \frac{DiagnosisAcc}{3} )\end{matrix} ] / 3 ,$$

where: σ₁+σ₂+σ₃=3, and 0≦σ₁, σ₂, σ₃≦3

and: StateDescScore=(0-100), EventAwarenessScore=(0-100), and DiagnosisAccuracy ε[0,1,2,3]

$$SkillUtil = [ \begin{matrix}{α}_{1} ( \frac{ExistingSkillUtil}{100} ) + {α}_{2} ( \frac{NewSkillUtil}{100} ) + \\ {α}_{3} ( \frac{JudgementUtil}{100} ) + {α}_{4} ( \frac{EducationUtil}{100} )\end{matrix} ] / 4 ,$$

where: α₁+α₂+α₃+α₄=4, and 0≦α₁, α₂, α₃≦4

and: *Util=(0-100).

$$Assuredness = [ {β}_{1} ( \frac{SelfConfidence}{100} ) + {β}_{2} ( \frac{100 - StressScore}{100} ) ] / 2$$

where: β₁+β₂=2, and 0≦β₁, β₂≦2

and: SelfConfidence=(0-100) and StressScore=(100-0).

FIG. 1B depicts a flowchart of example processing for calculating a cost benefit index, according to an embodiment of the invention. Control begins at block 150. Control then continues to block 152 where assessed data 110 (FIG. 1A) and process data 115 (FIG. 1A) are collected for the human-interface technology under investigation.

Control then continues to block 154 where the production value is determined using the omniscient generic model or the humanist generic model, as previously described above. Control then continues to block 156 where the utility cost is determined using the omniscient generic model or the humanist generic model, as previously described above. Control then continues to block 158 where the quality loss is determined using the omniscient generic model or the humanist generic model, as previously described above. Control then continues to block 160 where the fielding cost is determined using the omniscient generic model or the humanist generic model, as previously described above. Control then continues to block 162 where the event cost is determined using the omniscient generic model or the humanist generic model, as previously described above.

Control then continues to block 164 where the expected incident cost is determined using the omniscient generic model as previously described above. For the humanist generic model, block 164 is not used.

Control then continues to block 166 where the cost-benefit index is determined based on the production value, utility cost, quality loss, fielding cost, event cost and expected incident cost for the omniscient generic model or based on the production value, utility cost, quality loss, fielding cost, and event cost for the humanist generic model.

Control the continues to block 168 where the incident susceptibility index is determined for the humanist generic model, as previously described above. For the omniscient generic model, the incident susceptibility index need not be used.

Control then continues to block 169 where the cost benefit index and/or the incident susceptibility index are optionally displayed.

Control then continues to block 170 where a decision is made whether any more human-interface technologies need to be investigated. If the determination at block 170 is true, then control returns to block 152 where the calculation process for the next human-interface technology begins, as previously described above. If the determination at block 170 is false, then there are no more human-interface technologies of interest to process, so control continues to block 172 where the calculated cost-benefit indexes for all the human-interface technologies are compared and the best cost-benefit index is selected. Control then continues to block 199 where the function returns.

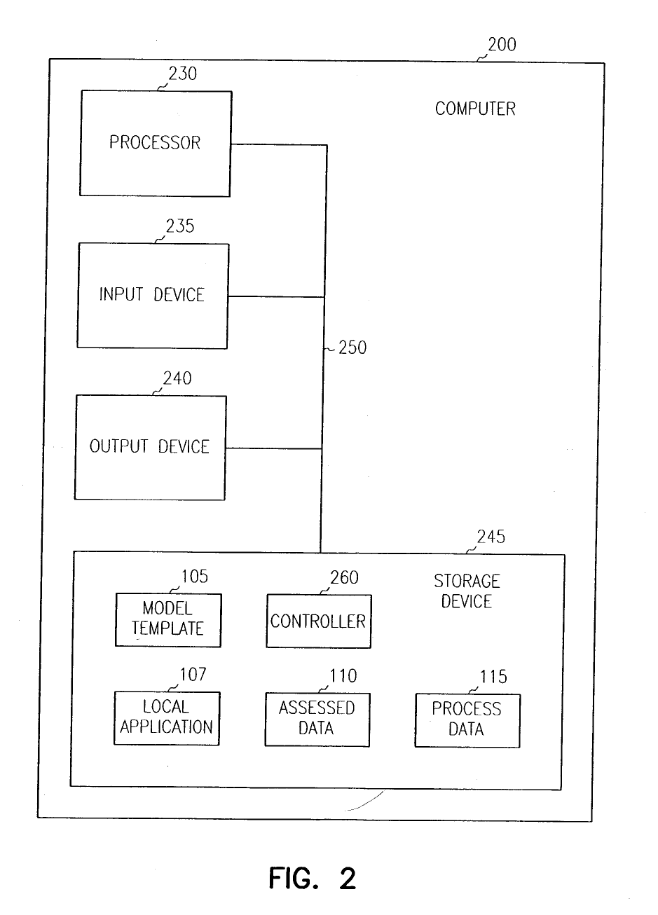

FIG. 2 depicts a block diagram of a computer 200 for implementing an embodiment of the invention. The computer 200 may include a processor 230, an input device 235, an output device 240, and a storage device 245, all connected via a bus 250.

The processor 230 may represent a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 230 may execute instructions and may include that portion of the computer 200 that controls the operation of the entire electronic device. Although not depicted in FIG. 2, the processor 230 typically includes a control unit that organizes data and program storage in memory and transfers data and other information between the various parts of the computer 200. In another embodiment, the processor 230 may not be present, and the computer 200 may be implemented with hardware in lieu of a processor-based system.

The input device 235 may accept input from a user. In an embodiment, the input device 235 may be a keyboard, but in other embodiments, the input device 235 may be a pointing device, mouse, trackball, keypad, touch-pad, touch screen, pointing stick, microphone, or any other appropriate input device. Although only one input device 235 is shown, in other embodiments any number of input devices of the same or of a variety of types may be present.

The output device 240 may communicate information to the user of the computer 200. The output device 240 may be a cathode-ray tube (CRT) based video display well known in the art of computer hardware. But, in other embodiments the output device 240 may be replaced with a liquid crystal display (LCD) based or gas, plasma-based, flat-panel display. In still other embodiments, any appropriate display device may be used. In yet other embodiments, a speaker that produces audio output may be used. Although only one output device 240 is shown, in other embodiments, any number of output devices of different types or of the same type may be present.

The storage device 245 may represent one or more mechanisms for storing data. For example, the storage device 245 may include read only memory (ROM), random access memory (RAM), magnetic disk storage media, optical storage media, flash memory devices, and/or other machine-readable media. In other embodiments, any appropriate type of storage device may be used. Although only one storage device 245 is shown, multiple storage devices and multiple types of storage devices may be present. Further, although the computer 200 is drawn to contain the storage device 245, it may be distributed across other electronic devices.

The storage device 245 may include a controller 260, which may perform the calculation 122, as previously described in FIGS. 1A and 1B. Referring again to FIG. 2, the storage device 245 may also include the model template 105, the local application 107, the assessed data 110, and the process data 115. Of course, the storage device 245 may also contain additional software and data (not shown), which are not necessary to understanding an embodiment of the invention. The controller 260 may contain instructions for execution on the processor 230 to perform functions as previously described above with reference to FIGS. 1A and 1B.

The bus 250 may represent one or more busses, e.g., PCI (Peripheral Component Interconnect), ISA (Industry Standard Architecture), X-Bus, EISA (Extended Industry Standard Architecture), or any other appropriate bus and/or bridge (also called a bus controller).

Although the computer 200 is shown to contain only a single processor 230 and a single bus 250, another embodiment of the invention applies equally to electronic devices that may have multiple processors and to electronic devices that may have multiple buses with some or all performing different functions in different ways. Although only one computer 200 is shown, in another embodiment any number of computers may be present.

The computer 200 may be implemented using any suitable hardware and/or software, such as a personal computer or other appropriate electronic device. Portable electronic devices, laptop or notebook computers, PDAs (Personal Digital Assistants), pocket computers, network appliances, minicomputers, and mainframe computers are examples of other possible configurations of the computer 200.

The hardware and software depicted in FIG. 2 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted.

As described in detail above, aspects of an embodiment pertain to specific apparatus and method elements implementable on an electronic device. In another embodiment, the invention may be implemented as a program product for use with an electronic device. The programs defining the functions of this embodiment may be delivered to an electronic device via a variety of signal-bearing media, which include, but are not limited to:

(1) information permanently stored on a non-rewriteable storage medium (e.g., read-only memory devices attached to or within an electronic device, such as a CD-ROM readable by a CD-ROM drive);

(2) alterable information stored on a rewriteable storage medium (e.g., a hard disk drive or diskette); or

(3) information conveyed to an electronic device by a communications medium, such as through a network, including wireless communications. Such signal-bearing media, when carrying machine-readable instructions that direct the functions of an embodiment of the present invention, represent embodiments of the present invention.

In the previous detailed description of exemplary embodiments of the invention, reference was made to the accompanying drawings (where like numbers represent like elements), which form a part hereof, and in which was shown by way of illustration specific exemplary embodiments in which the invention may be practiced. These embodiments were described in sufficient detail to enable those skilled in the art to practice embodiments of the invention, but other embodiments may be utilized and logical, mechanical, electrical, and other changes may be made without departing from the scope of the present invention. The previous detailed description is, therefore, not to be taken in a limiting sense, and the scope of embodiments of the present invention is defined only by the appended claims.

Numerous specific details were set forth to provide a thorough understanding of embodiments of the invention. However, embodiments of the invention may be practiced without these specific details. In other instances, well-known circuits, structures and techniques have not been shown in detail in order not to obscure embodiments of the invention.

What is claimed is:

1. A method comprising:
determining a production value of process flows;
determining a utility cost;
determining a quality loss;
determining a fielding cost;
determining an event cost; and
determining a cost-benefit index for a human-interface technology based on the production value, the utility cost, the quality loss, the fielding cost, and the event cost.

2. The method of claim 1, wherein determining the production value further comprises determining a sum of accumulated values of the process flows.

3. The method of claim 1, wherein determining the production value further comprises determining an integral over an observation time of a difference between a targeted flow rate and a flow deviation multiplied by a value of each of the process flows.

4. The method of claim 3, further comprising determining the flow deviation based on a target deviation, a range excursion, and a trajectory deviation.

5. The method of claim 1, wherein determining the utility cost further comprises determining a sum of a product of a flow rate of utility variables and costs of the utility variables.

6. The method of claim 1, wherein determining the quality loss further comprises determining a product of a flow rate of process variables and a quality penalty for each of the process variables.

7. The method of claim 1, wherein determining the fielding cost further comprises determining the fielding cost based on an operator training cost, a display development cost, an implementation cost and a display lifecycle.

8. The method of claim 1, wherein determining the event cost further comprises:
determining the event cost based on an equipment repair cost, a spill cleanup cost, a waste disposal cost, an investigation labor cost, a repair labor cost, an off specification blending cost, and a legal cost.

9. The method of claim 1, wherein determining the cost-benefit index further comprises determining the cost-benefit index based on an expected incident cost.

10. The method of claim 9, wherein determining the cost-benefit index further comprises determining the expected incident cost based on a risk mitigation factor, an event frequency, an average event cost, and a display lifecycle.

11. The method of claim 1, further comprising:
comparing the cost-benefit index to a second cost-benefit index for a second human-interface technology.

12. A signal-bearing medium encoded with instructions, wherein the instructions when executed comprise:
determining a plurality of cost-benefit indexes for a plurality of human-interface technologies, wherein each respective cost-benefit index is based on a respective production value, a respective utility cost, a respective quality loss, a respective fielding cost, and a respective event cost; and
determining a best human-interface technology based on comparing the plurality of cost-benefit indexes.

13. The signal-bearing medium of claim 12, wherein determining the plurality of cost-benefit indexes further comprises determining the respective production value based on a sum of accumulated values of product flows.

14. The signal-bearing medium of claim 12, wherein determining the plurality of cost-benefit indexes further comprises determining the respective utility cost based on a sum of a product of a flow rate of utility variables and costs of the utility variables.

15. The signal-bearing medium of claim 12, further comprising:
determining an incident susceptibility index based on process variable performance, process variance, and a risk mitigation factor.

16. A computer comprising:
a processor; and
storage connected to the processor, wherein the storage is encoded with instructions that when executed on the processor comprise:
determining a plurality of cost-benefit indexes for a plurality of human-interface technologies, wherein each respective cost-benefit index is based on a respective production value, a respective utility cost, a respective quality loss, a respective fielding cost, and a respective event cost; and
determining a best human-interface technology based on comparing the plurality of cost-benefit indexes.

17. The computer of claim 16, wherein the instructions further comprise:
determining an incident susceptibility index based on process variable performance, process variance, and a risk mitigation factor.

18. The computer of claim 17, wherein determining the incident susceptibility index further comprises determining an integral over time of a sum of individual process variable variances.

19. The computer of claim 16, wherein the storage further comprises a model template of weights to be input to the instructions.

20. The computer of claim 16, wherein the instructions further comprise:
collecting assessed data and process data for input to the instructions.
